(19) United States
(12) Patent Application Publication
(10) Pub. No.: US 2008/0238900 A1
(43) Pub. Date: Oct. 2, 2008

(54) Driving device of electrophoretic display panel, driving method of electrophoretic display panel, electrophoretic display device and electronic apparatus

(75) Inventor: Hidetoshi Saito, Suwa-shi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 12/075,961

(22) Filed: Mar. 15, 2008

(30) Foreign Application Priority Data
Mar. 29, 2007 (JP) 2007-086779

(51) Int. Cl. G06F 3/038; G09G 3/34

(52) U.S. Cl. 345/204; 345/107

(57) ABSTRACT

Provided is a driving device of a segment display type electrophoretic display panel including a common electrode, a plurality of segment electrodes which face the common electrode, and a dispersion system containing electrophoretic particles arranged between the common electrode and the segment electrodes, the driving device including: a driving circuit which supplies a driving voltage having a voltage value according to plural pieces of display data, which are supplied as a series of serial data, to the segment electrodes, wherein the driving circuit includes a switching circuit which switches the driving voltage according to the display data to a voltage value according to reverse data of the display data, on the basis of at least one external control signal input to the driving circuit, independent of the display data.

### BACKGROUND

1. Technical Field

The present invention relates to a driving device of a segment display type electrophoretic display panel, a driving method of the electrophoretic display panel, an electrophoretic display device, and an electronic apparatus.

2. Related Art

As non-emission display device, an electrophoretic display device using an electrophoretic display phenomenon is known (for example, see JP-A-2002-116733, JP-A-2003-140199, JP-A-2004-004714 and JP-A-2004-101746). The electrophoretic display phenomenon indicates that, when an electric field is applied to a dispersion system in which particles (electrophoretic particles) are dispersed in liquid (dispersion medium), the particles migrate by Coulomb force.

A driving method of such an electrophoretic display device includes a segment display method. In the segment display method, an electrode for driving an electrophoretic display is divided and display control is performed in each segment electrode, thereby forming a display pattern on an electrophoretic display panel.

This electrophoretic display device includes the electrophoretic display panel and a driving device for driving the electrophoretic display panel. In the electrophoretic display panel, a dispersion system composed of electrophoretic particles and a dispersion medium is interposed between a transparent common electrode and a plurality of segment electrodes which face the common electrode. The driving device of the electrophoretic display panel applies a voltage to the common electrode and the segment electrodes according to an image to be displayed and moves the electrophoretic particles to any one electrode side, thereby forming a desired image on the electrophoretic display panel.

The circuit configuration of the driving device of the electrophoretic display panel will be described with reference to FIGS. 20 and 21. As shown in FIG. 20, the driving device 60 includes an input interface unit 61 and an electrophoretic display panel (EPD) driving unit 62.

The input interface unit 61 receives serial data SDAT composed of a series of voltage data, which will be set at the segment electrodes, from an external computer (not shown). The serial data SDAT is input to a shift register composed of D flip-flops X10 to X12 and is converted into parallel data by the shift register. The converted parallel data is latched in a data latch composed of D flip-flops X20 to X22. The D flip-flops X20 to X22 supply the latched voltage data to XDIN terminals of output circuits X60 to X62 of the EPD driving unit 62 through level shifters X30 to X32. The level shifters X30 to X32 output the voltage data having an L level (a low-potential power source VSS) to the output circuits X60 to X62 without shifting the level thereof, and shift the level of the voltage data having a HL level (a low voltage level LVDD as a high-potential power source) to a high voltage level HVDD, which can drive the dispersion system, and output the voltage data, of which the level is shifted, to the output circuits X60 to X62.

The input interface unit 61 receives voltage data DCOM, which will be set at the common electrode, from the external computer as a voltage signal SCOM. The input interface unit 61 supplies the voltage data DCOM to a data terminal DIN of an output circuit X63 through a level shifter X33. When an output instruction signal SEN for instructing an output is received from the external computer, the input interface unit 61 supplies the output instruction signal SEN to OE terminals of the output circuits X60 to X63 as an output control signal OE.

When the output control signal OE indicating a non-output instruction is received, the output circuits X60 to X63 configuring the EPD driving unit 62 set DOUT terminals to high impedance Hi-Z. When the output control signal OE indicating an output instruction is received, the output circuits X60 to X63 apply a driving voltage according to the voltage data from the level shifters X30 to X33 to segment electrodes VSEG and a common electrode VCOM.

Each of the output circuits X60 to X63 is, for example, configured by three-state inverter shown in FIG. 21. In the output circuit X60 composed of the three-state inverter, when transistors QP22 and QN22 which are turned on/off by the output control signal OE are turned off, the DOUT terminal is set to Hi-Z and the segment electrode VSEG0 is set to Hi-Z. In the three-state inverter, when the transistors QP22 and QN22 are turned on, the voltage data of which the level is shifted by the level shifter X30 is supplied from the DOUT terminal to the segment electrode VSEG0 as a driving voltage.

However, in the driving device for serially transmitting the voltage data, even when the voltage level of one of the plurality of segment electrodes is changed, the voltage data of all the segment electrodes, that is, the serial data SDAT, needs to be newly supplied such that the overall voltage data latched in the data latch is updated. For example, even in a case of displaying a reverse image of a display image or even in a case of displaying a simple image, such as a full-white display or full-black display, in which a whole display unit is made white or black, the voltage data needs to be supplied to all the segment electrodes and the common electrode in order to perform the display. Accordingly, the power consumption of the driving device of the electrophoretic display panel is increased, a burden on data processing for forming the serial data (a series of voltage data) and unnecessary power consumption thereof are increased even at a transmission side of the voltage data, and the low power consumption of the overall system including the electrophoretic display panel cannot be realized.

### SUMMARY

An advantage of some aspects of the invention is that it provides a driving device of an electrophoretic display panel, a driving method of the electrophoretic display panel, an electrophoretic display device, and an electronic apparatus, which are capable of suppress the increase of unnecessary power consumption.

According to an aspect of the invention, there is provided a driving device of a segment display type electrophoretic display panel including a common electrode, a plurality of segment electrodes which face the common electrode, and a dispersion system containing electrophoretic particles arranged between the common electrode and the segment electrodes, the driving device including a driving circuit which supplies a driving voltage having a voltage value according to plural pieces of display data, which are supplied as a series of serial data, to the segment electrodes, wherein the driving circuit includes a switching circuit which switches the driving voltage according to the display data to a voltage value according to reverse data of the display data, on the basis of at least one external control signal input to the driving circuit, independent of the display data.

According to the driving device of the electrophoretic display panel of the invention, a right image display for displaying an image according to plural pieces of display data supplied as a series of serial data and a reverse image display for displaying an image according to reverse data of the display data are switched on the basis of an external control signal. That is, the right image display can be switched to the reverse image display without supplying data corresponding to the reverse data of the display data as the serial data. In addition, the reverse image display can be switched to the right image display without supplying the serial data. Accordingly, when the right image display is switched to the reverse image display or the reverse image display is switched to the right image display, the supply of the serial data composed of plural pieces of display data can be omitted and thus unnecessary power consumption which occurs in the driving device due to the supply of the serial data can be reduced. Since the unnecessary power consumption at a transmission side for forming the serial data can be also reduced by omitting the supply of the serial data, the power consumption of the overall system including the driving device and the electrophoretic display panel can be reduced.

In the driving device of the electrophoretic display panel, the switching circuit may switch the driving voltage to a voltage value having a predetermined level for displaying a predetermined gradation, regardless of the display data, on the basis of at least two external control signals.

According to the driving device of the electrophoretic display panel, all segments are displayed with the predetermined gradation (monochromatic display) by two external control signals. That is, all the segments can be monochromatically displayed without supplying the serial composed of plural pieces of display data for displaying the predetermined gradation. Even in a case of monochromatically display all the segments, since the supply of the serial data can be omitted, unnecessary power consumption which occurs due to the supply of the serial data can be reduced.

In the driving device of the electrophoretic display panel, the at least two external control signals may include a first external control signal and a second external control signal, the switching circuit may include first and second transfer gates which are complementarily opened or closed on the basis of the level of the display data, and the first external control signal may be supplied to the segment electrodes through the first transfer gate as the driving voltage and the second external control signal may be supplied to the segment electrodes through the second transfer gate as the driving voltage.

According to the driving device of the electrophoretic display panel, the first external control signal and the second external control signal are output as the driving voltage through the first and second transfer gates which are complementarily switched on the basis of the signal level of the display data. Accordingly, by changing the signal levels of the first external control signal and the second control signal to desired levels, the monochromatic display, the right image display and the reverse image display of all the segments can be easily switched without supplying new display data.

In the driving device of the electrophoretic display panel, each of the first transfer gate and the second transfer gate may be configured by connecting a P-channel MOS transistor and an N-channel MOS transistor in parallel.

According to the driving device of the electrophoretic display panel, the P-channel MOS transistor and the N-channel MOS transistor are connected in parallel to configure the first and second transfer gate. The driving device of the electrophoretic display panel according to claim 3, wherein the external control signal outputs any one of a high-potential power source level, a low-potential power source level or high impedance.

In the known driving device 60, the segment electrode VSEG can be set to high impedance by only setting the output control signal OE input to the output circuits X60 to X62 to the signal level indicating the non-output instruction. Accordingly, in the known driving device 60, it is difficult to set only some of segment electrodes to the high impedance while the dispersion system is driven.

In contrast, according to the driving device of the electrophoretic display panel, since the external control signal output as the driving voltage can be set to the high impedance, it is possible to easily set only some of segment electrodes to the high impedance while the dispersion system is driven.

In the driving device of the electrophoretic display panel, the driving circuit may include a three-value output circuit which receives first and second generation signals for generating the external control signal and outputs any one of the high-potential power source level, the low-potential power source level or the high impedance, according to the levels of the first and second generation signals.

According to the driving device of the electrophoretic display panel, any one of the high-potential power source level, the low-potential power source level or the high impedance is output from the three-value output circuit as the external control signal.

In the driving device of the electrophoretic display panel, an output circuit which alternately applies the low-potential power source level and the high-potential power source level to the common electrode in each predetermined period, according to the voltage data supplied independent of the serial data may be included, and, when a voltage having the same potential as the driving voltage supplied to a predetermined segment electrode is supplied to the common electrode, the external control signal having the high impedance may be supplied to the predetermined segment electrode.

In general, if the predetermined segment electrode and the common electrode have the same potential while the dispersion system is driven, a potential difference does not occur between the predetermined segment electrode and the common electrode, an electric field does not occur and thus the movement of the electrophoretic particles is stopped. For example, if the driving voltage having the opposite level is applied to the segment electrode adjacent to the predetermined segment electrode, leakage current may occur between the both segment electrodes and a current path may occur. If the current path occurs, unnecessary power consumption occurs.

In contrast, according to the driving device of the electrophoretic display panel, when the predetermined segment electrode and the common electrode have the same potential, the external control signal having the high impedance is supplied to the predetermined segment electrode. Accordingly, since the occurrence of the leakage current between the adjacent segment electrodes is suppressed, unnecessary power consumption due to the leakage current is reduced.

In the driving device of the electrophoretic display panel, the driving circuit may include a serial/parallel converting circuit which includes a shift register and a data latch and converts the serial data to parallel data, and a high-potential power source which can shift a power source voltage from a low voltage level to a high voltage level for driving the dispersion system may be connected to the data latch.

According to the driving device of the electrophoretic display panel, by switching the power supply voltage to the high voltage level by the high-potential power, for example, after the serial data is latched in the data latch, data of which the level is shifted can be output from the data latch. That is, the data latch can function as the level shifter. Accordingly, the level shifter necessary for shifting the voltage level of the display data from the low voltage level to the high voltage level can be omitted.

According to another aspect of the invention, there is provided a driving device of a segment display type electrophoretic display panel including a common electrode, a plurality of segment electrodes which face the common electrode, and a dispersion system containing electrophoretic particles arranged between the common electrode and the segment electrodes, the driving device including a driving circuit which supplies a driving voltage having a voltage value according to plural pieces of display data, which are supplied as a series of serial data, to the segment electrodes, wherein the driving circuit includes a switching circuit which switches the driving voltage to a voltage value having a predetermined level, regardless of the display data, on the basis of at least two external control signals input to the driving circuit, independent of the display data.

According to the driving device of the electrophoretic display panel of the invention, all segments are displayed with the predetermined gradation (monochromatic display) by two external control signals. That is, all the segments can be monochromatically displayed without supplying the serial composed of plural pieces of display data for displaying the predetermined gradation. In a case of monochromatically display all the segments, since the supply of the serial data can be omitted, unnecessary power consumption which occurs due to the supply of the serial data can be reduced. Since the unnecessary power consumption at a transmission side for forming the serial data can be also reduced by omitting the supply of the serial data, the power consumption of the overall system including the driving device and the electrophoretic display panel can be reduced.

According to another aspect of the invention, there is provided a driving method of a segment display type electrophoretic display panel including a common electrode, a plurality of segment electrodes which face the common electrode, and a dispersion system containing electrophoretic particles arranged between the common electrode and the segment electrodes, the driving method including: at a driving circuit, supplying a driving voltage having a voltage value according to plural pieces of display data, which are supplied as a series of serial data, to the segment electrodes; and switching the driving voltage according to the display data to a voltage value according to reverse data of the display data, on the basis of at least one external control signal input to the driving circuit, independent of the display data.

According to the driving method of the electrophoretic display panel of the invention, a right image display for displaying an image according to plural pieces of display data supplied as a series of serial data and a reverse image display for displaying an image according to reverse data of the display data are switched on the basis of an external control signal. That is, the right image display can be switched to the reverse image display without supplying data corresponding to the reverse data of the display data as the serial data. In addition, the reverse image display can be switched to the right image display without supplying the serial data. Accordingly, when the right image display is switched to the reverse image display or the reverse image display is switched to the right image display, the supply of the serial data composed of plural pieces of display data can be omitted and thus unnecessary power consumption which occurs in the driving device due to the supply of the serial data can be reduced. Since the unnecessary power consumption at a transmission side for forming the serial data can be also reduced by omitting the supply of the serial data, the power consumption of the overall system including the driving device and the electrophoretic display panel can be reduced.

The driving method of the electrophoretic display panel further includes switching the driving voltage to a voltage value having a predetermined level for displaying a predetermined gradation, regardless of the display data, on the basis of at least two external control signals.

According to the driving method of the electrophoretic display panel, all segments are displayed with the predetermined gradation (monochromatic display) by two external control signals. That is, all the segments can be monochromatically displayed without supplying the serial composed of plural pieces of display data for displaying the predetermined gradation. Even in a case of monochromatically display all the segments, since the supply of the serial data can be omitted, unnecessary power consumption which occurs due to the supply of the serial data can be reduced.

An electrophoretic display device of the invention includes the driving device.

According to the electrophoretic display device of the invention, unnecessary power consumption can be reduced.

An electronic apparatus of the invention includes all apparatuses including the electrophoretic display device and includes a display device, a television device, an electronic book, an electronic paper, a watch, a calculator, a mobile phone, a personal digital assistant and so on. In addition, the electronic apparatus of the invention includes a concept other than the “apparatus”, for example, a flexible object having a paper shape/film shape, an immovable estate such as a wall to which the object is attached, and a mobile object such as a vehicle, an air vehicle, a ship or the like.

### BRIEF DESCRIPTION OF THE DRAWINGS

The invention will be described with reference to the accompanying drawings, wherein like numbers reference like elements.

FIG. 1 is a cross-sectional view showing main portions of an electrophoretic display panel according to a first embodiment of the invention.

FIG. 2 is a block diagram showing a driving device.

FIG. 3 is a block diagram showing the internal configuration of the driving device.

FIG. 4 is a circuit diagram showing a level shifter.

FIG. 5 is a circuit diagram showing an output circuit.

FIG. 6 is a timing chart illustrating the operation of the driving device.

FIG. 7 is a timing chart illustrating the operation of the driving device.

FIG. 8 is a table illustrating the levels of first and second control signals.

FIG. 9 is a timing chart illustrating the operation of the driving device.

FIG. 10 is a table illustrating the levels of the first and second control signals.

FIG. 11 is a block diagram showing a driving device according to a second embodiment of the invention.

FIG. 12 is a circuit diagram showing a three-value output circuit.

FIG. 13 is a table illustrating the levels of the first and second control signals.

FIG. 14 is a block diagram showing a driving device according to a third embodiment of the invention.

FIG. 15 is a timing chart showing a variation in level of a high-potential power source.

FIGS. 16A to 16C are perspective views showing examples of an electronic apparatus.

FIG. 17 is a circuit diagram showing an output circuit according to a modified example.

FIG. 18 is a circuit diagram showing an output circuit according to a modified example.

FIG. 19 is a block diagram showing a driving circuit according to a modified example.

FIG. 20 is a block diagram showing a known driving device.

FIG. 21 is a circuit diagram showing a known output circuit.

### DESCRIPTION OF EXEMPLARY EMBODIMENTS

### First Embodiment

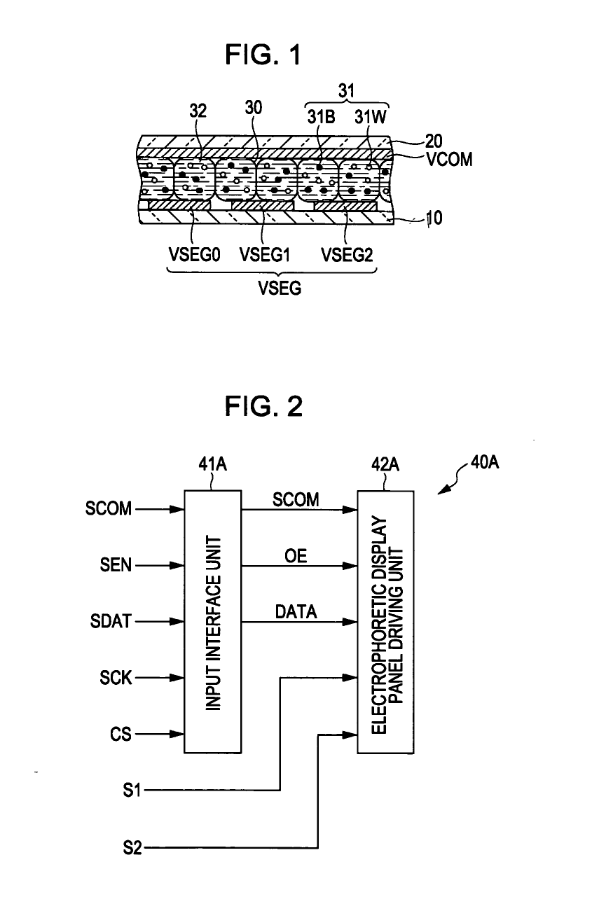

Hereinafter, an electrophoretic display device according to a first embodiment of the invention will be described with reference to FIGS. 1 to 10. The electrophoretic display device includes an electrophoretic display panel shown in FIG. 1 and a driving device 40A shown in FIG. 2.

FIG. 1 is a cross-sectional view showing main portions of the electrophoretic display panel. As shown in FIG. 1, the electrophoretic display panel includes a segment substrate 10 formed of glass or semiconductor and a counter substrate 20 formed of a transmissive material such as glass or plastic, both of which face each other. On one surface of the segment substrate 10, a plurality (in the present embodiment, 79) of segment electrodes VSEG, for example, segment electrodes VSEG0, VSEG1 and VSEG2 of FIG. 1, are formed. On one surface of the counter substrate 20, a flat common electrode VCOM formed of a transparent conductive material such as indium tin oxide (ITO) is formed.

The segment substrate 10 and the counter substrate 20 are attached to each other at a predetermined gap such that the electrodes formed on the surfaces thereof face each other. In the gap between the segment substrate 10 and the counter substrate 20, a plurality of micro capsules 30 in which electrophoretic particles 31 and a dispersion medium 32 are sealed are arranged. In FIG. 1, white particles 31W charged with a negative polarity and black particles 31B charged with a positive polarity are used as the electrophoretic particles 31. In order to avoid settling due to the weight of the electrophoretic particles 31, the specific gravity of the electrophoretic particles 31 is set to be equal to that of the dispersion medium 32.

When a low-potential power source VSS (for example, 0 V) is applied to the segment electrode VSEG and a high voltage level HVDD (for example, 15 V) is applied to the common electrode VCOM, the positive black particles 31B are collected at the side of the segment electrode VSEG and the negative white particles 31W are collected at the side of the common electrode VCOM. Accordingly, a white color is written to the segment corresponding to the segment electrode VSEG. In contrast, when the high voltage level HVDD is applied to the segment electrode VSEG and the low-potential power source VSS is applied to the common electrode VCOM, the negative white particles 31W are collected at the side of the segment electrode VSEG and the positive black particles 31B are collected at the side of the common electrode VCOM. Accordingly, a black color is written to the segment corresponding to the segment electrode VSEG. When the voltage is not applied to the segment electrodes VSEG and the common electrode VCOM, the electrodes are held at a high impedance state Hi-Z so as to prevent current leakage.

Next, the driving device for driving the electrophoretic display panel will be described with reference to FIGS. 2 to 5.

As shown in FIG. 2, the driving device 40A includes an input interface unit 41A and an electrophoretic display panel (EPD) driving unit 42A. The driving device 40A is configured by an integrated circuit and, although not shown, includes an oscillator for generating a clock signal which is internally used or a DC-DC converter for boosting a low voltage level LVDD (for example, 3 V) of a battery to the high voltage level HVDD (for example, 15 V) which can drive a dispersion system including the electrophoretic particles 31 and the dispersion medium 32.

The input interface unit 41A receives voltage data DCOM, which will be set at the common electrode VCOM, from an external computer (not shown) as a voltage signal SCOM and outputs the voltage signal SCOM to the EPD driving unit 42A.

The input interface unit 41A receives serial data SDAT composed of a series of voltage data (for example, 79 pieces of voltage data), which will be set at the segment electrodes VSEG, from the external computer. The input interface unit 41A converts the serial data SDAT into parallel data using a shift register and holds the voltage data of the electrodes in a data latch. The input interface unit 41A performs a serial-parallel converting process of the serial data SDAT using a transmission clock SCK and a supply signal CS indicating a data supply period.

The EPD driving unit 42A receives a first control signal S1 and a second signal S2 from the external computer, independent of the signal received from the input interface unit 41A. The EPD driving unit 42A supplies a predetermined driving voltage to a corresponding segment electrode VSEG on the basis of the first and second control signals S1 and S2 and the serial data SDAT. The EPD driving unit 42A supplies a predetermined driving voltage to the common electrode VCOM on the basis of the voltage data DCOM received from the input interface unit 41A.

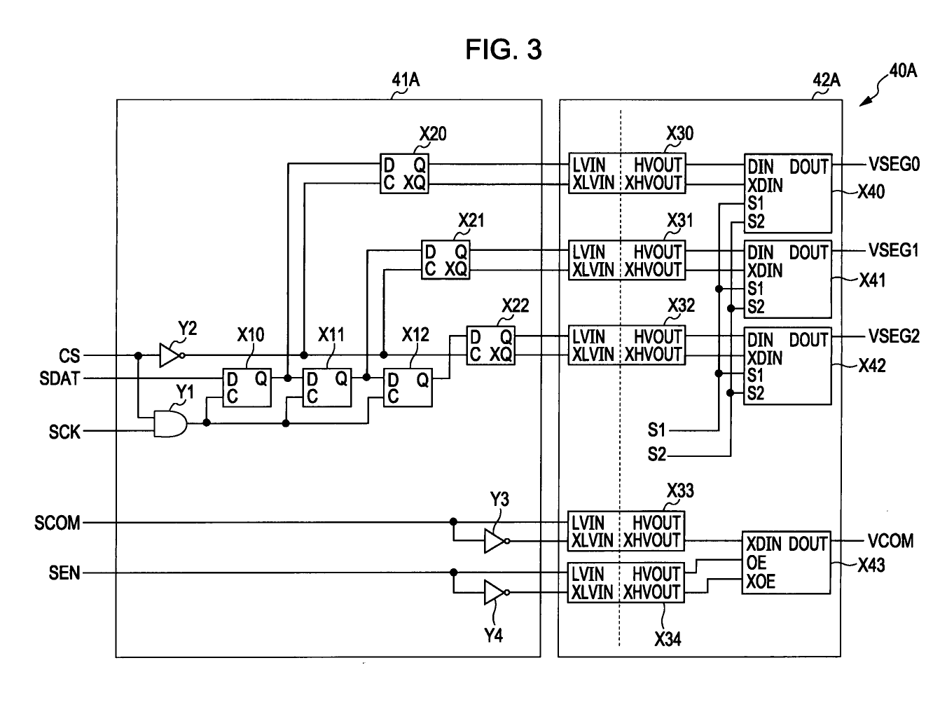

Next, the internal configurations of the input interface unit 41A and the EPD driving unit 42A will be described with reference to FIG. 3. In FIG. 3, for example, a circuit for processing three pieces of voltage data D0 to D2 among the 79 pieces of serial data SDAT and one piece of voltage data DCOM will be described. A circuit located at the left side of a dotted line of FIG. 3 is driven by the low voltage level LVDD and A circuit located at the right side of the dotted line is driven by the high voltage level HVDD.

As shown in FIG. 3, the shift register is configured by data flip-flops (D flip-flops) X10 to X12 which are connected in series. The serial data SDAT is input to a D terminal of the first D flip-flop X10 and the transmission clock SCK is input to C terminals of the D flip-flops X10 to X12 through an AND circuit Y1. Q outputs of the D flip-flops X10 to X12 are input to the D terminals of the next D flip-flops and are input to D terminals of the data latches X20 to X22. The supply signal CS is input to C terminals of the data latches X20 to X22 through an inverter circuit Y2. The data latches X20 to X22 receive the Q outputs of the D flip-flops X10 to X12 according to the supply signal CS and the data latches X20 to X22 are respectively configured by D flip-flops.

The supply signal CS is input to the AND circuit Y1 and controls the transmission of the transmission clock SCK input to the AND circuit Y1. The control of the transmission of the transmission clock SCK is set such that a data latch operation of the data latches X20 to X22 is performed after the elapse of a data shift period of the serial data SDAT.

Q outputs of the data latches X20 to X22, that is, the voltage data D0 to D2, are input to LVIN terminals of level shifters X30 to X32, respectively. Reverse Q (XQ) outputs of the data latches X20 to X22 are input to XLVIN terminals of the level shifters X30 to X32, respectively.

The voltage signal SCOM output from the external computer is input to an LVIN terminal of a level shifter X33 through the input interface unit 41A. The voltage signal SCOM is input to an XLVIN terminal of the level shifter X33 through an inverter circuit Y3.

An output instruction signal SEN output from the external computer is input to an LVIN terminal of the level shifter X34 through the input interface unit 41A. The output instruction signal SEN is input to an XLVIN terminal of the level shifter X34 through an inverter circuit Y4. The input interface unit 41A includes the AND circuit Y1, the inverter circuits Y2 to Y4, the D flip-flops X10 to X12 and the data latches X20 to X22.

The level shifter X30 to X34 shift the voltage levels of the signals input to the LVIN terminals and the XLVIN terminals thereof and output the signals, of which the levels are shifted, through HVOUT terminals and XHVOUT terminals.

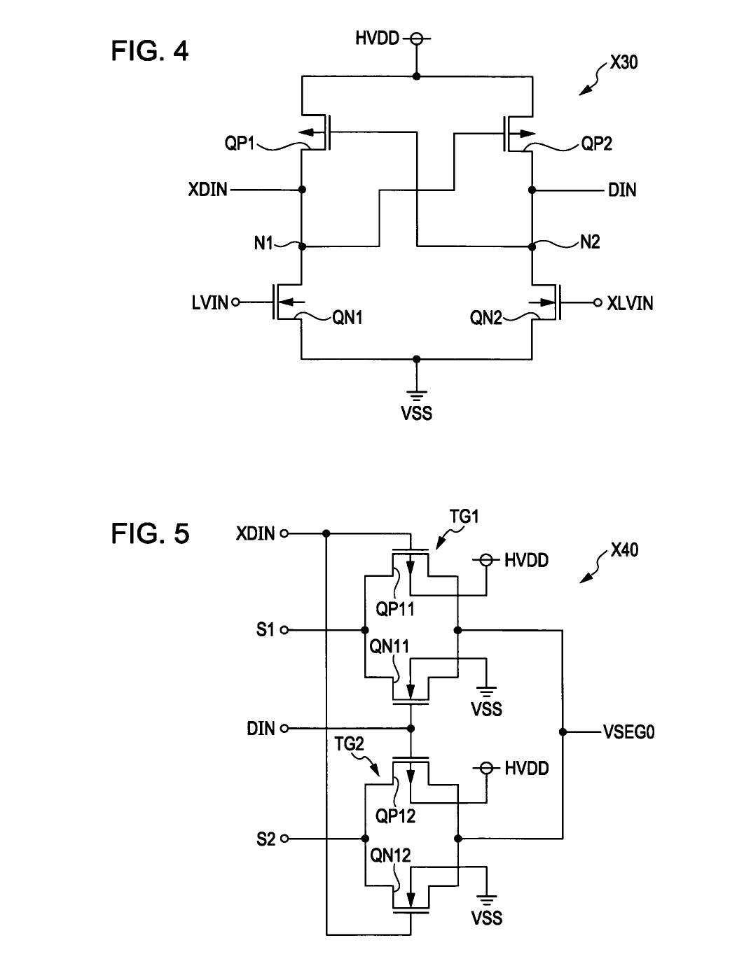

As shown in FIG. 4, the level shifter X30 includes two P-channel MOS transistor QP1 and QP2 and two N-channel MOS transistors QN1 and QN2. The transistors QP1 and QN1 and the transistors QP2 and QN2 are connected between the high voltage level HVDD as the high-potential power source HVDD and the low-potential power source VSS in series, respectively. A gate of the transistor QN1 is connected to the LVIN terminal and receives the Q output (voltage data D0) of the data latch X20 which is located at the previous stage of the level shifter X30. A gate of the transistor QN2 is connected to the XLVIN terminal and receives the XQ output (reverse voltage data) of the data latch X20.

A gate of the transistor QP1 is connected to a node N2 between the transistor QP2 and QN2 and a gate of the transistor QP2 is connected to a node N1 between the transistor QP1 and QN1. The voltage data D0 of which the level is shifted is output from the node N2 as a data signal DIN, and the reverse voltage data of which the level is shifted as reverse data is output from the node N1 as a reverse data signal XDIN.

For example, when the voltage data D0 having an L level (the low-potential power source VSS) is input to the LVIN terminal and the reverse voltage data having a HL level (the low voltage level LVDD as the high-potential power source) is input to the XLVIN terminal, the transistor QN1 is turned off and the transistor QN2 is turned on. Then, since the low-potential power source VSS is applied to the gate of the transistor QP1, the transistor QP1 is turned on and the reverse data signal XDIN having a H level (the high voltage level HVDD as the high-potential power source) is output. Since the high voltage level HVDD is applied to the gate of the transistor QP2, the transistor QP2 is turned off and the data signal DIN having the L level (the low-potential power source VSS) is output. When the voltage data D0 having the HL level is input to the LVIN terminal, the data signal DIN having the H level is output and the reverse data signal XDIN having the L level is output. The level shifters X31 to X34 have the substantially same configuration as the level shifter X30.

The level shifters X30 to X33 output the voltage data having the L level without shifting the level thereof, and shift the level of the voltage data having the HL level to the high voltage level HVDD (H level), which can drive the dispersion system, and output the voltage data of which the level is shifted.

As shown in FIG. 3, the data signals DIN of the level shifters X30 to X32 are input to DIN terminals of output circuits X40 to X42 for supplying the driving voltage to the segment electrodes VSEG0 to VSEG2, respectively. The reverse data signal XDIN of the level shifters X30 to X32 are input to XDIN terminals of the output circuits X40 to X42, respectively. The first control signal S1 and the second control signal S2 are directly input from the external computer to S1 terminals and S2 terminals of the output circuits X40 to X42. The output circuits X40 to X42 generate the driving voltage on the basis of the signals DIN, XDIN, S1 and S2 input to the terminals thereof and supply the driving voltage to the segment electrodes VSEG corresponding thereto.

As shown in FIG. 5, the output circuit X40 includes two transfer gates TG1 and TG2. A gate of an N-channel MOS transistor QN11 configuring the transfer gate TG1 and a gate of a P-channel MOS transistor QP12 configuring the transfer gate TG2 are connected to the DIN terminal and receive the data signal DIN from the level shifter X30. A gate of a P-channel MOS transistor QP11 configuring the transfer gate TG1 and a gate of an N-channel MOS transistor QN12 configuring the transfer gate TG2 are connected to the XDIN terminal and receive the reverse data signal XDIN from the level shifter X30. The first control gate S1 is input to the transfer gate TG1 and the second control signal S2 is input to the transfer gate TG2. The outputs of the transfer gates TG1 and TG2 are applied to the segment electrode VSEG0 as the driving voltage. The high voltage level HVDD is supplied to back gates of the transistors QP11 and QP12 and the low-potential power source VSS is supplied to back gates of the transistors QN11 and QN12.

For example, when the data signal DIN having the H level is input and the reverse data signal XDIN having the L level is input, the transfer gate TG1 is conducted and the transfer gate TG2 is turned off. The first control signal S1 input to the conducted transfer gate TG1 is supplied to the segment electrode VSEG0 as the driving voltage. In contrast, when the data signal DIN having the L level is input and the reverse data signal XDIN having the H level is input, the transfer gate TG1 is turned off and the transfer gate TG2 is conducted. Then, the second control signal S2 input to the conducted transfer gate TG2 is supplied to the segment electrode VSEG0 as the driving voltage. The output circuits X41 and X42 have the substantially same configuration as the output circuit X40.

The output circuits X40 to X42 control the switching of the transfer gates TG1 and TG2 according to the level of the data signal DIN (the reverse data signal XDIN) and supply the control signals input to the conducted transfer gates to the segment electrodes VSEG0 to VSEG2 as the driving voltage, respectively.

The reverse data signal XDIN of the level shifter X33 which receives the voltage signal SCOM is input to the XDIN terminal of the output circuit X43 for supplying the driving voltage to the common electrode VCOM.

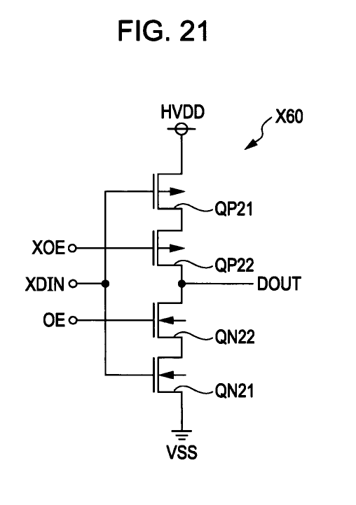

The level shifter X34 which receives the output instruction signal SEN outputs the output instruction signal SEN having the L level without shifting the level thereof, or shifts the level of the output instruction signal SEN having the HL level into the H level and outputs the output instruction signal, of which the level is shifted, to an output enable (OE) terminal of the output circuit X43 as the output control signal OE. A reverse output control signal XOE of the level shifter X34 is input to an XOE terminal of the output circuit X43. The output circuit X43 has the substantially same configuration as the output circuit X60 composed of the three-state inverter shown in FIG. 21.

Accordingly, in a period in which the output control signal OE having the L level indicating a non-output instruction is input, the transistors QP22 and QN22 are turned off and thus the DOUT terminal of the output circuit X43 is set to high impedance Hi-Z. In a period in which the output control signal OE having the H level indicating an output instruction is input, the output circuit X43 supplies the voltage data DCOM, of which the level is shifted by the level shifter X33, to the common electrode VCOM as the driving voltage.

The EPD driving unit 42A is configured by the level shifters X30 to X34 and the output circuits X40 to X43.

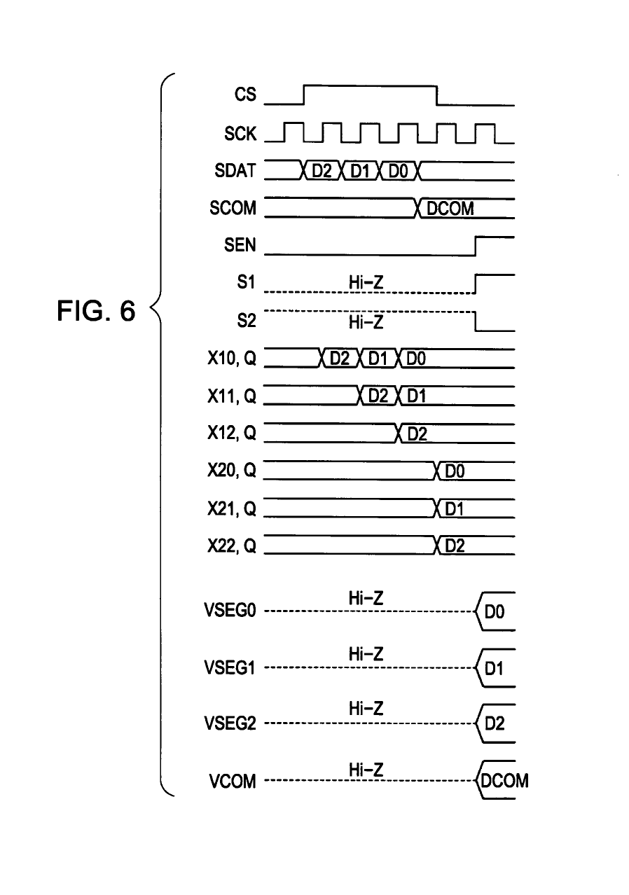

The operation of the driving device 40A will be described with reference to FIG. 6.

The external computer supplies the serial data SDAT functioning as the voltage data D0 to D2 of the segment electrodes VSEG, the voltage signal SCOM functioning as the voltage data DCOM of the common electrode VCOM, the transmission clock SCK, the supply signal CS indicating the existence period of the serial data SDAT with the HL level to the driving device 40A.

When the supply signal CS becomes the HL level, one input of the AND circuit Y1 becomes the HL level (the low voltage level LVDD as the high-potential power source) and thus the transmission clock SCK is supplied to the C terminals of the D flip-flops X10 to X12 as the output signal of the AND circuit Y1. In synchronization with a falling edge of the transmission clock SCK, the serial data SDAT (the voltage data D0 to D2) is supplied from the external computer to the D terminals of the D flip-flops X10 to X12. The D flip-flops X10 to X12 receive the voltage data input to the D terminals and sequentially shift the serial data SDAT, in synchronization with a rising edge of the transmission clock SCK.

When the overall voltage data of the serial data SDAT is transmitted from the external computer and is held in the shift register (the D flip-flops X10 to X12), the supply signal CS falls. Accordingly, the data latches X20 to X22 receive the Q outputs of the D flip-flops X10 to X12 and latch the voltage data D0, D1 and D2 of the segment electrodes VSEG0 to VSEG2. The data latches X20 to X22 supply the latched voltage data D0 to D2 to the LVIN terminals of the level shifters X30 to X32 as the Q outputs, respectively. The level shifters X30 to X32 output the Q outputs having the L level without shifting the level thereof or shift the level of the Q outputs having the HL level to the H level and output the Q outputs to the DIN terminals of the output circuits X40 to X42 as the data signal DIN. At this time, one of the two transfer gates TG1 and TG2 of the output circuits X40 to X42 is conducted according to the level of the data signal DIN. Since the transfer gates TG1 and TG2 receive the first control signal S1 and the second control signal S2 from the external computer, the output circuits X40 to X42 supply the first control signal S1 or the second control signal S2 input to the conducted transfer gate to the segment electrodes VSEG0 to VSEG2 corresponding thereto as the driving voltage, respectively.

As shown in FIG. 6, when the first control signal S1 transitions from the high impedance state Hi-Z to the H level and the second control signal S2 transitions from Hi-Z to the L level, the output circuits X40 to X42 supply the voltage data D0 to D2, of which the level is shifted, to the segment electrodes VSEG0 to VSEG2 corresponding thereto as the driving voltage, respectively.

Meanwhile, the external computer supplies the voltage data DCOM of the common electrode VCOM to the EPD driving unit 42A through the input interface unit 41A as the voltage signal SCOM. That is, the voltage data DCOM is input to the LVIN terminal of the level shifter X33 and is input to the XLVIN terminal of the level shifter X33 through the inverter circuit Y3 as the reverse voltage data. The level shifter X33 outputs the reverse voltage data having the L level or shifts the level of the reverse voltage data having the HL level to the H level and outputs the reverse voltage data, of which the level is shifted, to the XDIN terminal of the output circuit X43 as the reverse data signal XDIN.

Next, when the level of the output instruction signal SEN supplied from the external computer is shifted to the HL level indicating the output instruction, the output control signal OE, of which the level is shifted to the H level by the level shifter X34, is input to the OE terminal of the output circuit X43. At this time, the output control signal OE having the H level functions as the output enable signal to activate the output circuit X43. Accordingly, the DOUT terminal of the output circuit X43 transitions from Hi-Z to the reverse signal of the reverse data signal XDIN, that is, the voltage data DCOM of which the level is shifted. The output circuit X43 supplies the voltage data DCOM, of which the level is shifted, to the common electrode VCOM as the driving voltage.

Accordingly, the driving voltages of the segment electrodes VSEG0 to VSEG2 and the common electrode VCOM are set.

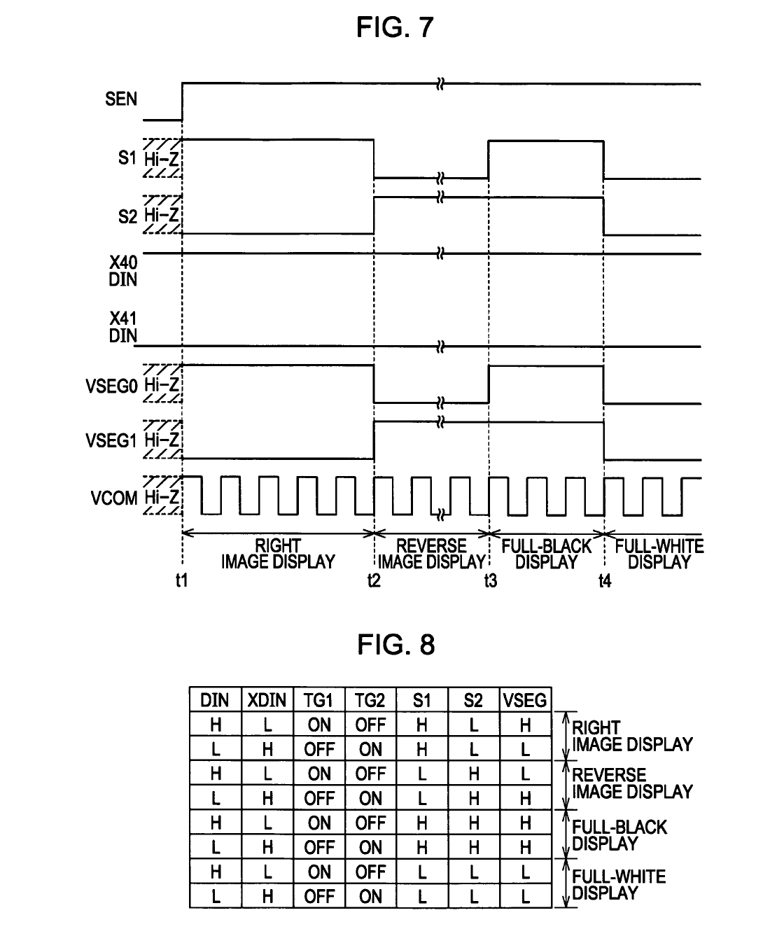

FIG. 7 is a timing chart showing the driving voltages applied to the segment electrodes VSEG0 to VSEG2 when the levels of the first and second control signals S1 and S2 are variously shifted at timings t1, t2, t3 and t4. Here, a case where voltage data D0 having the HL level, which is displayed with black color, voltage data D1 having the L level, which is displayed with white color, are input will be described.

The external computer sets the driving voltages of the electrodes and stops the transmission of the serial data SDAT and the transmission clock SCK to the driving device 40A.

As shown in FIG. 7, in a period in which the output instruction signal SEN is at the HL level (the output control signal OE is at the H level), the driving voltage having the H level and the driving voltage having the L level are alternately supplied to the common electrode VCOM in each predetermined period. In a case where the driving voltage of the common electrode VCOM transitions from the H level to the L level or from the L level to the H level, the voltage data DCOM having the level corresponding thereto is supplied from the external computer to the input interface unit 41A.

Meanwhile, when the voltage data D0 having the HL level is input, the data signal DIN of which the H level is shifted to the L level by the level shifter X30 is input to the DIN terminal of the output circuit X40. When the voltage data D1 having the L level is input, the data signal DIN having the L level is input to the DIN terminal of the output circuit X40.

Next, at the timing t1, the first control signal S1 transitions from Hi-Z to the H level and the second control signal S2 transitions from Hi-Z to the L level, by the external computer. Then, as shown in FIG. 8, in the output circuit X40 to which the data signal DIN having the H level is input, the transfer gate TG1 is conducted and the transfer gate TG2 is turned off. At this time, since the first control signal S1 input to the conducted transfer gate TG1 is at the H level which is equal to the level of the data signal DIN, the driving voltage having the H level is supplied to the segment electrode VSEG0. In the output circuit X41 to which the data signal DIN having the L level is input, the transfer gate TG1 is turned off and the transfer gate TG2 is conducted. At this time, since the second control signal S2 input to the conducted transfer gate TG2 is at the L level which is equal to the level of the data signal DIN, the driving voltage having the L level is supplied to the segment electrode VSEG1.

When the first control signal S1 having the H level and the second control signal S2 having the L level are supplied, the data signal DIN (the voltage data of which the level is shifted) is supplied to the segment electrode as the driving voltage and thus a right image according to the serial data SDAT is displayed on the electrophoretic display panel. That is, in a period in which the driving voltage having the H level is applied to the common electrode VCOM, a potential difference occurs between the common electrode and the segment electrode VSEG1 to which the driving voltage having the L level is applied, the positive black particles 31B is collected at the side of the segment electrode VSEG1 and the negative white particles 31W are collected at the side of the common electrode VCOM. Accordingly, a white color is written to the segment corresponding to the segment electrode VSEG1. In a period in which the driving voltage having the L level is applied to the common electrode VCOM, a potential difference between the common electrode and the segment electrode VSEG0 to which the driving voltage having the H level is applied, the negative white particles 31W are collected at the side of the segment electrode VSEG0 and the positive black particles 31B are collected at the side of the common electrode VCOM. Accordingly, a black color is written to the segment corresponding to the segment electrode VSEG0.

Next, at the timing t2 shown in FIG. 7, the first control signal S1 transitions from the H level to the L level and the second control signal S2 transitions from the L level to the H level, by the external computer. Then, as shown in FIG. 8, the output circuit X40 in which the transfer gate TG1 is conducted according to the data signal DIN having the H level supplies the driving voltage having the L level to the segment electrode VSEG0, because the first control signal S1 input to the transfer gate TG1 is at the L level which is equal to the level of the reverse data signal XDIN. The output circuit X41 in which the transfer gate TG2 is conducted according to the data signal DIN having the L level supplies the driving voltage having the H level to the segment electrode VSEG1, because the second control signal S2 input to the transfer gate TG2 is at the H level which is equal to the level of the reverse data signal XDIN.

When the first control signal S1 having the L level and the second control signal S2 having the H level are supplied, the reverse data signal XDIN (the reverse voltage data of which the level is shifted) is supplied to the segment electrode as the driving signal and thus a reverse image according to the serial data SDAT is displayed on the electrophoretic display panel. Accordingly, by only switching the levels of the control signals S1 and S2, it is possible to switch the display of the electrophoretic display panel from a right image display to a reverse image display, without switching the serial data SDAT.

Next, at the timing t3 shown in FIG. 7, the first and second control signals S1 and S2 are set to the H level by the external computer. In this case, since the first and second control signals S1 and S2 input to the transfer gates TG1 and TG2 are at the H level, even when any one of the transfer gates TG1 and TG2 is conducted, the driving voltage having the H level is always supplied to the segment electrode. That is, the output circuits X40 to X42 always supply the driving voltage having the H level to the segment electrodes VSEG0 to VSEG2 corresponding thereto, regardless of the data signal DIN (the voltage data D0 to D2). Accordingly, in a period in which the driving voltage having the L level is applied to the common electrode VCOM, a potential difference occurs between the common electrode VCOM and all the segment electrodes VSEG, the negative white particles 31W are collected at the side of all the segment electrode VSEG, and the positive black particles 31B are collected at the side of the common electrode VCOM. Accordingly, the black color is written to all the segments. In a period in which the first and second control signals S1 and S2 are set to the H level, all the segments becomes the black display (full-black display).

Next, at the timing t4 shown in FIG. 7, the first and second control signals S1 and S2 are set to the L level by the external computer. In this case, since the first and second control signals S1 and S2 input to the transfer gates TG1 and TG2 are at the L level, even when any one of the transfer gates TG1 and TG2 is conducted, the driving voltage having the L level is always supplied to the segment electrode. That is, the output circuits X40 to X42 always supply the driving voltage having the L level to the segment electrodes VSEG0 to VSEG2 corresponding thereto, regardless of the data signal DIN (the voltage data D0 to D2). Accordingly, in a period in which the driving voltage having the H level is applied to the common electrode VCOM, a potential difference occurs between the common electrode VCOM and all the segment electrodes VSEG, the positive black particles 31B are collected at the side of all the segment electrode VSEG, and the negative white particles 31W are collected at the side of the common electrode VCOM. Accordingly, the white color is written to all the segments. In a period in which the first and second control signals S1 and S2 are set to the L level, all the segments becomes the white display (full-white display).

In the driving device 40A according to the present embodiment, it is possible to easily switch a display mode such as the right image display, the reverse image display, the full-black display or the full-white display, by shifting the levels of the first control signal S1 and the second control signal S2 without changing the input serial data SDAT. Accordingly, it is possible to reduce unnecessary power consumption and perform an erasing operation with a high speed.

However, as shown in FIG. 7, in a case where the driving voltages having the H level and the L level are alternately applied to the common electrode VCOM, a period in which the common electrode VCOM and the segment electrode VSEG have the same potential exists. That is, in the right image display period of FIG. 7, in a period in which the driving voltage having the L level is applied to the common electrode VCOM, the segment electrode VSEG1 and the common electrode VCOM have the same potential. At this time, since the voltage difference does not occur between the segment electrode VSEG1 and the common electrode VCOM, an electric field is not generated and thus the movement of the electrophoretic particles 31 is stopped. When the driving voltage having the H level which is opposite to the L level is applied to an adjacent segment electrode (here, the segment electrode VSEG0), leakage current may occur between the segment electrodes VSEG0 and VSEG1 and thus a current path occurs. When the current path occurs, unnecessary power consumption may occur and the mobility of the electrophoretic particles 31 may be changed.

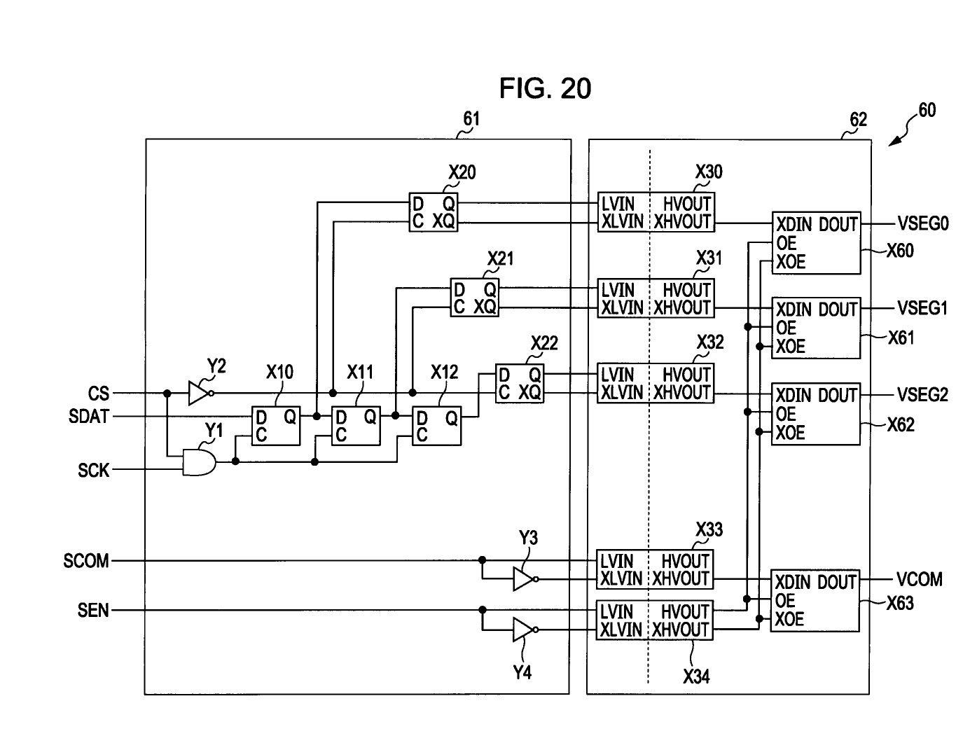

The present inventors found that the occurrence of the leakage current is suppressed by setting the segment electrode VSEG having the same potential as the common electrode VCOM to the high impedance. Here, as shown in FIG. 20, in the known driving device 60, the segment electrode VSEG can be set to the high impedance by only setting the output control signal OE input to the output circuits X60 to X62 to the signal level indicating the non-output instruction. Accordingly, in the known driving device 60, it is difficult to supply the driving voltage having the H level or the L level to one segment electrode and set the other segment electrode to the high impedance.

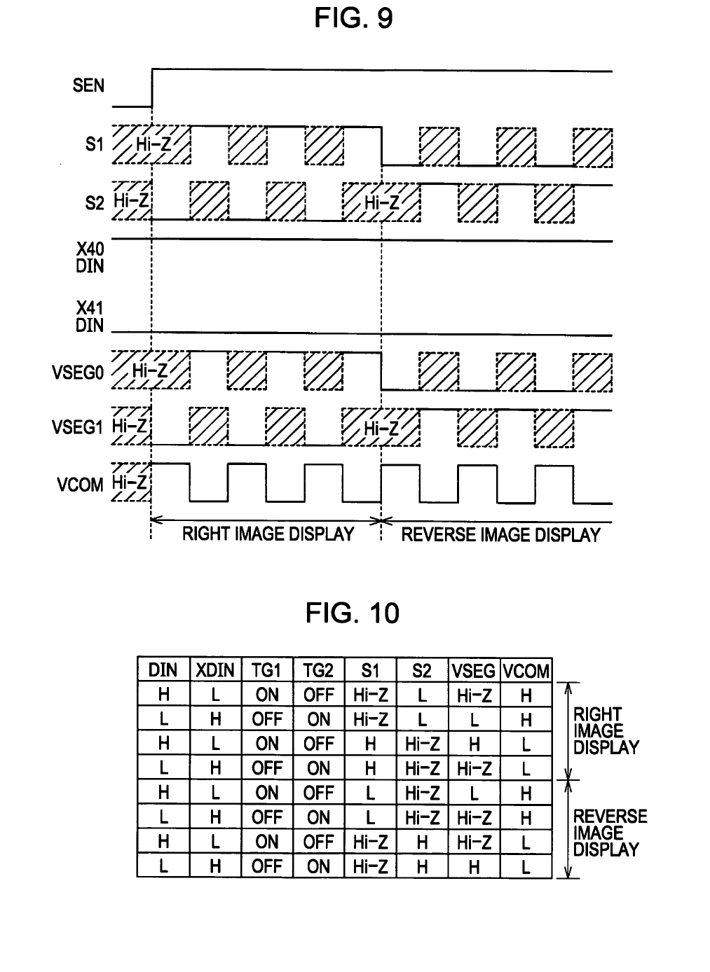

In contrast, in the driving device 40A according to the present embodiment, as shown in FIGS. 9 and 10, it is possible to easily set the segment electrode having the same potential as the common electrode VCOM to the high impedance by setting any one of the first control signal S1 and the second control signal S2 to the high impedance.

FIG. 9 is a timing chart in a case where the segment electrode having the same potential as the common electrode VCOM is set to the high impedance. Here, similar to FIG. 7, a case where voltage data D0 having the HL level, which is displayed with a black color, and voltage data D1 having the L level, which is displayed with a white color, are input and a right image is displayed will be described.

As shown in FIG. 9, the external computer sets the first control signal S1 to the high impedance Hi-Z and sets the second control signal S2 to the L level, in a period in which the driving voltage having the H level is applied to the common electrode VCOM. Then, as shown in FIG. 10, the output circuit X40 in which the transfer gate TG1 is conducted according to the data signal DIN having the H level sets the segment electrode VSEG0 to Hi-Z, because the first control signal S1 input to the transfer gate TG1 is at Hi-Z. The output circuit X41 in which the transfer gate TG2 is conducted according to the data signal DIN having the L level supplies the driving voltage having the L level to the segment electrode VSEG1, because the second control signal S2 input to the transfer gate TG2 is at the L level which is equal to the level of the data signal DIN. Accordingly, the white color is written to the segment corresponding to the segment electrode VSEG1.

Meanwhile, as shown in FIG. 9, the external computer sets the first control signal S1 to the H level and sets the second control signal S2 to Hi-Z, in a period in which the driving voltage having the L level is applied to the common electrode VCOM. Then, as shown in FIG. 10, the output circuit X40 in which the transfer gate TG1 is conducted according to the data signal DIN having the H level supplies the driving voltage having the H level to the segment electrode VSEG1, because the first control signal S1 input to the transfer gate TG1 is at the H level which is equal to the level of the data signal DIN. Accordingly, the black color is written to the segment corresponding to the segment electrode VSEG0. The output circuit X41 to which the data signal DIN having the L level is input sets the segment electrode VSEG1 to Hi-Z, because the second control signal S2 input to the conducted transfer gate TG2 is at Hi-Z.

It is possible to display the right image according to the serial data SDAT on the electrophoretic display panel while the segment electrode VSEG having the same potential as the common electrode VCOM is set to Hi-Z, by controlling the levels of the first and second control signals S1 and S2.

In the driving device 60 according to the present embodiment, as shown in FIGS. 9 and 10, it is possible to display the reverse image according to the serial data SDAT on the electrophoretic display panel while the segment electrode VSEG having the same potential as the common electrode VCOM is set to Hi-Z, by controlling the levels of the first and second control signals S1 and S2. In this case, with respect to the first and second control signals S1 and S2, the first control signal S1 is set to the L level and the second control signal S2 is set to Hi-Z, in the period in which the driving voltage having the H level is applied to the common electrode VCOM. In the period in which the driving voltage having the L level is applied to the common electrode VCOM, the first control signal S1 is set to Hi-Z and the second control signal S2 is set to the H level.

According to the present embodiment, the following effects can be obtained.

(1) According to the present embodiment, the right image display and the reverse image display are switched by shifting the levels of the first and second control signals S1 and S2. Accordingly, it is possible to switch the right image display and the reverse image display without supplying new serial data SDAT for displaying the reverse image. Accordingly, when the right image display is switched to the reverse image display or the reverse image display is switched to the right image display, the supply of the serial data SDAT can be omitted. Thus, it is possible to reduce unnecessary power consumption which occurs in the driving device 40A by supplying the serial data SDAT. When the supply of the serial data SDAT is omitted, unnecessary power consumption at the side of the external computer for forming the serial data SDAT can be also reduced and thus overall power consumption of the system including the driving device 40A and the electrophoretic display panel can be reduced.

(2) According to the present embodiment, the levels of the first and second control signals S1 and S2 are set to the H level or the L level, thereby realizing the full-black display or the full-white display. Accordingly, the full-black display and the full-white display can be realized without supplying, for example, the serial data SDAT for the full-black display, that is, the serial data SDAT for setting the overall voltage data D0 to D2 to the HL level. Therefore, in the full-black display and the full-white display, since the supply of the serial data SDAT can be omitted, it is possible to reduce unnecessary power consumption which occurs by supplying the serial data SDAT.

For a refresh operation of the electrophoretic display panel, the full-black display and the full-white display may be repeated plural times. In this case, according to the driving device 40A of the present embodiment, the full-black display and the full-white display can be repeated by reversing the levels of the first and second control signals S1 and S2. Accordingly, the refresh operation can be performed with low power consumption.

(3) According to the present embodiment, each of the output circuits X40 to X42 is configured by the transfer gates TG1 and TG2 which are complementarily switched on the basis of the level of the data signal DIN. The first control signal S1 is supplied to the segment electrode VSEG through the transfer gate TG1 and the second control signal S2 is supplied to the segment electrode VSEG through the transfer gate TG2. Accordingly, the control signal input to the conducted transfer gate is supplied to the segment electrode VSEG. Therefore, it is possible to easily switch the right image display, the reverse image display, the full-black display and the full-white display without supplying new serial data SDAT, by shifting the levels of the first control signal S1 and the second control signal S2.

(4) According to the present embodiment, the control signal supplied to the segment electrode VSEG having the same potential as the common electrode VCOM is set to the high impedance. Accordingly, since the occurrence of the leakage current between the adjacent segment electrodes VSEG is suitable suppressed, it is possible to reduce power consumption.

### Second Embodiment

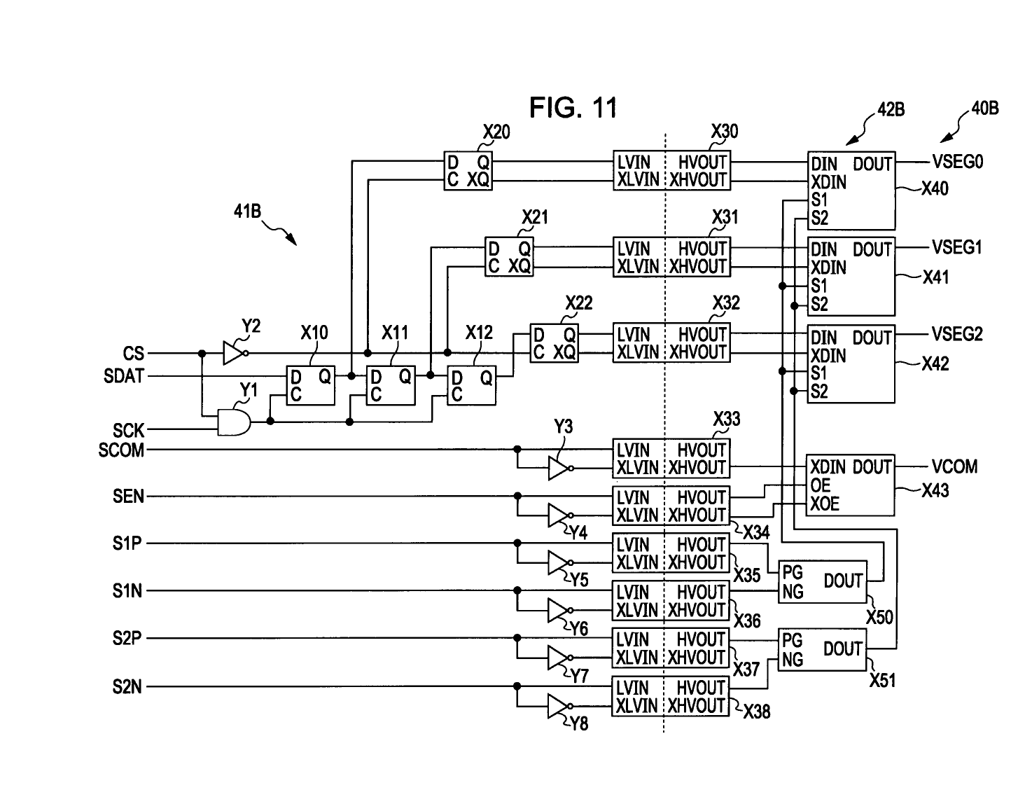

Hereinafter, a second embodiment of the invention will be described with reference to FIGS. 11 to 13. The present embodiment is different from the first embodiment in a method of generating the first control signal S1 and the second control signal S2. Hereinafter, the present embodiment will be described, concentrating on differences from the first embodiment. The same members as the members shown in FIGS. 1 to 10 are denoted by the same reference numerals and the detailed description thereof will be omitted.

As shown in FIG. 11, generation signals S1P and S1N for generating the first control signal S1 and generation signals S2P and S2N for generating the second control signal S2 are input to an input interface unit 41B. The generation signals S1P, S1N, S2P and S2N are respectively input to LVIN terminals of level shifters X35 to X38 and are respectively input to XLVIN terminals of the level shifters X35 to X38 through inverter circuits Y5 to Y8.

The level shifters X35 to X38 have the substantially same configuration as the level shifter X30 shown in FIG. 4. The level shifters X35 to X38 boost the high-potential power source levels of the generation signals S1P, S1N, S2P and S2N input to the LVIN terminals from the low voltage level LVDD to the high voltage level HVDD and output the output signals to three-value output circuits X50 and X51 through HVOUT terminals thereof.

The three-value output circuits X50 and X51 output any one of the H level, the L level or the high impedance Hi-Z to the S1 terminals or the S2 terminals of the output circuits X40 to X42 as the first control signal S1 or the second control signal S2, on the basis of the output signals input to PG terminals and NG terminals thereof.

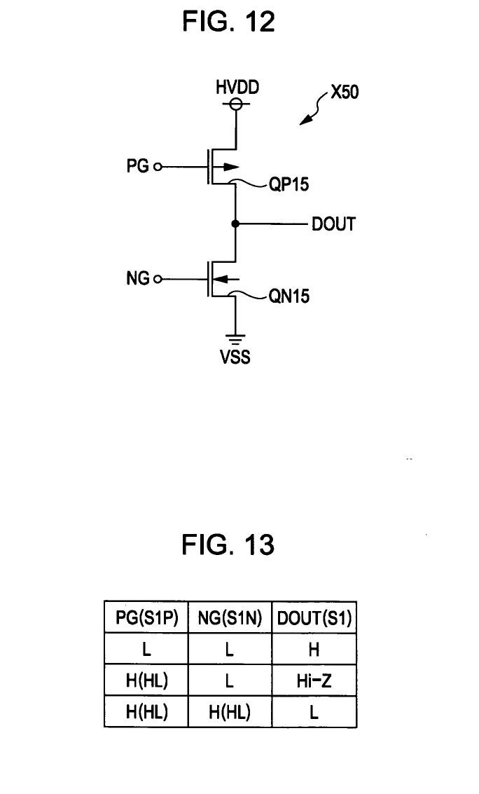

As shown in FIG. 12, the three-value output circuit X50 includes a P-channel MOS transistor QP15 and an N-channel MOS transistor QN15, both of which are connected in series between the high voltage level HVDD and the low-potential power source VSS. A gate of the transistor QP15 is connected to the PG terminal and receives the output signal based on the generation signal S1P. A gate of the transistor QN15 is connected to the NG terminal and receives the output signal based on the generation signal S1N. A node between the transistors QP15 and QN15 is connected to an output terminal DOUT and the first control signal S1 is output from the output terminal DOUT.

For example, when the generation signal S1P having the L level is input and the generation signal S1N having the L level is input, the output signal having the L level is input to the PG terminal and the NG terminal of the three-value output circuit X50. Then, since the transistor QP15 is turned on and the transistor QN15 is turned off, the first control signal S1 having the H level is output (see FIG. 13).

When the generation signal S1P having the HL level is input and the generation signal SiN having the L level is input, the output signal having the H level is input to the PG terminal of the three-value output circuit X50 and the output signal having the L level is input to the NG terminal thereof. Then, since the transistors QP15 and QN15 are turned off, the first control signal S1 having Hi-Z is output.

When the generation signal S1P having the HL level is input and the generation signal SiN having the HL level is input, the output signal having the H level is input to the PG terminal and the NG terminal of the three-value output circuit X50. Then, since the transistor QP15 is turned off and the transistor QN15 is turned on, the first control signal S1 having the L level is output. The three-value output circuit X51 has the substantially same configuration as the three-value output circuit X50.

According to the present embodiment, the following effect can be obtained in addition to the effects (1) to (4) of the first embodiment.

(5) According to the present embodiment, the three-value output circuits X50 and X51 output any one of the high voltage level HVDD, the low-potential power source VSS or the high impedance as the first and second control signals S1 and S2, on the basis of the levels of the generation signals S1P, S1N, S2P and S2N of which the levels are shifted. Accordingly, the first and second control signals S1 and S2 of the three-value output can be generated from the generation signals S1P, S1N, S2P and S2N.

### Third Embodiment

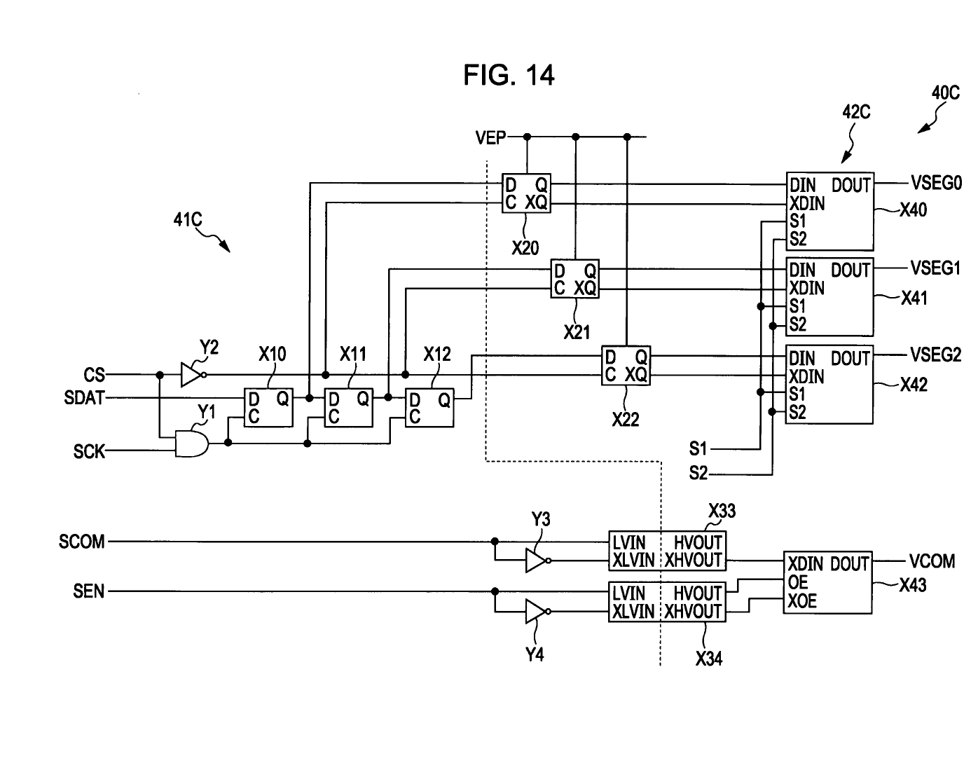

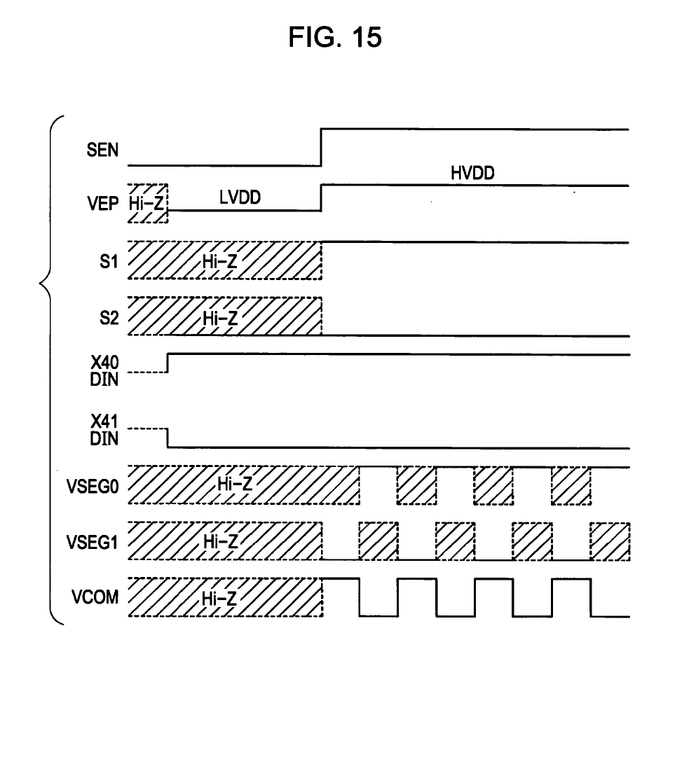

Hereinafter, a third embodiment of the invention will be described with reference to FIGS. 14 and 15. The present embodiment is different from the first embodiment in the data latches X20 to X22. Hereinafter, the present embodiment will be described, concentrating on differences from the first embodiment. The same members as the members shown in FIGS. 1 to 13 are denoted by the same reference numerals and the detailed description thereof will be omitted.

In the present embodiment, as shown in FIG. 14, the level shifters X30 to X32 are omitted from the driving device 40A shown in FIG. 3. The data latches X20 to X22 are connected to a high-potential power source VEP which can change a voltage value (power source voltage) between the low voltage level LVDD and the high voltage level HVDD.

In the present embodiment, as shown in FIG. 15, the high-potential power source VEP is changed from the low voltage level LVDD to the high voltage level HVDD, in synchronization with the rise of the output instruction signal SEN for controlling the output of the driving voltage to the common electrode VCOM.

That is, the data latches X20 to X22 are driven by the high-potential power source VEP having the low voltage level LVDD which is equal to the HL level of the voltage data D0 to D2 of the serial data SDAT, until the serial data SDAT is latched by the data latches X20 to X22. When the latched voltage data D0 to D2 (parallel data) is output to the output circuits X40 to X42 after latching the serial data SDAT, the high-potential power source VEP connected to the data latches X20 to X22 is boosted from the low voltage level LVDD to the high voltage level HVDD and thus the data latches X20 to X22 are driven by the high-potential power source VEP having the high voltage level HVDD. Accordingly, the data latches X20 to X22 can output the Q outputs (the voltage data of which the level is shifted), in which the high-potential power source is boosted from the low voltage level LVDD to the high voltage level HVDD, to the DIN terminals of the output circuits X40 to X42.

According to the present embodiment, the following effect can be obtained in addition to the effects (1) to (4) of the first embodiment.

(6) According to the present embodiment, the high-potential power source VEP which can change the voltage value between the low voltage level LVDD and the high voltage level HVDD is connected to the data latches X20 to X22 and the high-potential power source VEP is changed from the low voltage level LVDD to the high voltage level HVDD after the serial data SDAT is latched. Accordingly, since the voltage data D0 to D2 of which the level is shifted to the high voltage level HVDD can be output from the data latches X20 to X22, the level shifters X30 to X32 of FIG. 3 can be omitted.

### Fourth Embodiment

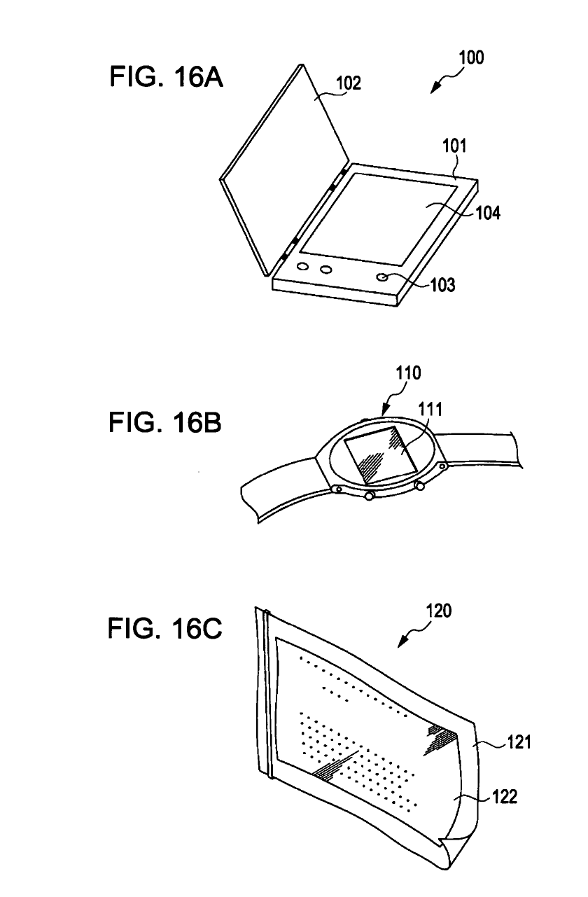

Next, an example of applying each of the electrophoretic display devices according to the first to third embodiment to an electronic apparatus will be described with reference to FIG. 16.

FIG. 16A is a perspective view showing the configuration of an electronic book which is an example of the electronic apparatus. The electronic book 100 includes a book-shaped frame 101, a (openable) cover 102 which is rotatably provided with respect to the frame 101, an operation unit 103, and a display unit 104 composed of the electrophoretic display device.

FIG. 16B is a perspective view showing the configuration of a wristwatch which is an example of the electronic apparatus. The wristwatch 110 includes a display unit 111 composed of the electrophoretic display device.

FIG. 16C is a perspective view showing the configuration of an electronic paper which is an example of the electronic apparatus. The electronic paper 120 includes a main body 121 composed of a rewritable sheet having flexibility and the same texture as paper and a display unit 122 composed of the electrophoretic display device.

Even in these cases, the display units 104, 111 and 122 composed of the electrophoretic display device have the same effects as the above-described embodiments. As a result, the electronic book 100, the wristwatch 110 and the electronic paper 120 can rapidly switch the right image display, the reverse image display, the full-black display and the full-white display while unnecessary power consumption is suppressed.

### Other Embodiments

The above-described embodiments may be embodied by the following aspects.

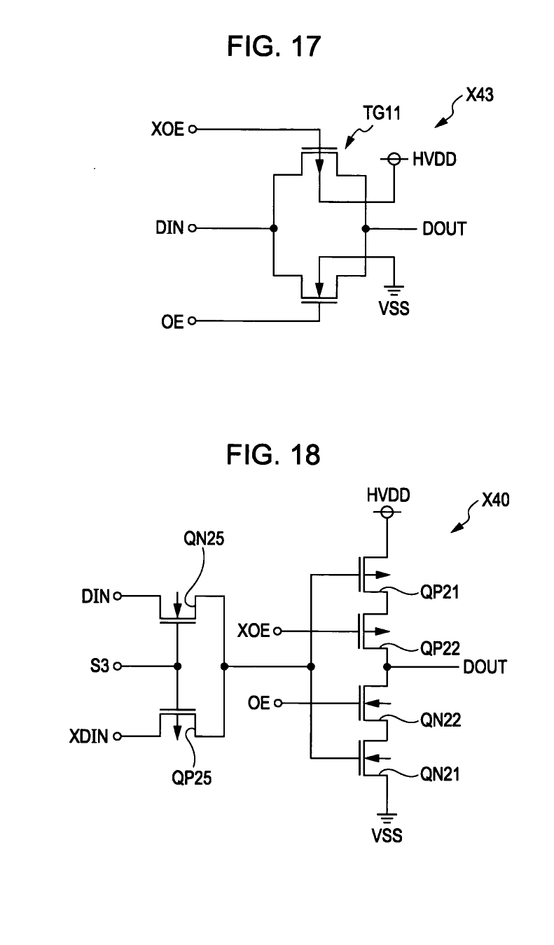

In the above-described embodiment, the output circuit X43 for supplying the driving voltage to the common electrode VCOM is the three-value output inverter. The invention is not limited thereto and, as shown in FIG. 17, the output circuit X43 may be configured by one transfer gate TG11.

Alternatively, similar to the output circuits X40 to X42, the output circuit X43 may be configured by two transfer gates TG1 and TG2. In this case, it is preferable that control signals different from the control signals S1 and S2 are supplied.

The output circuits X40 to X42 of the above-described embodiments may be configured by a circuit shown in FIG. 18. That is, the DIN terminal is connected to an N-channel MOS transistor QN25, the XDIN terminal is connected to a P-channel MOS transistor QP25, and a control signal S3 is supplied to gates of the transistors QN25 and QP25. The outputs of the transistors QN25 and QP25 are connected to the input of the three-state inverter. According to this circuit, by inverting the level of the control signal S3, the right image display can be switched to the reverse image display or the reverse image display can be switched to the right image display without switching the serial data SDAT.

In the above-described embodiments, the transfer gates TG1 and TG2 are configured by connecting the P-channel MOS transistor and the N-channel MOS transistor in parallel. The invention is not limited thereto and each transfer gate may be, for example, configured by a single N-channel MOS transistor.

Although the reverse image display, the full-white display and the full-black display are performed by shifting the levels of the first and second control signals S1 and S2 in the above-described embodiments, some of the displays (for example, the full-white display and the full-black display) may be omitted. For example, in a case of performing the reverse image display, since the serial data SDAT does not need to be newly supplied, it is possible to reduce power consumption compared with the known driving device 60. The reverse image display may be omitted.

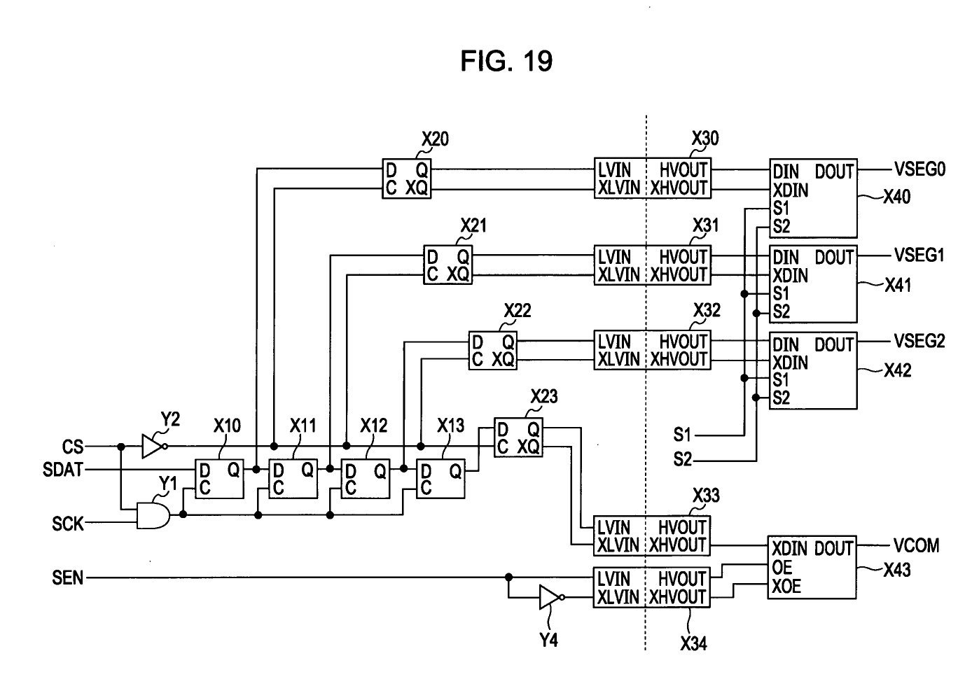

Although the high voltage level HVDD and the low-potential power source VSS are alternately applied to the common electrode VCOM in each predetermined period in the above-described embodiments, the invention is not limited thereto. A constant voltage having a GND level may be applied to the common electrode VCOM. In this case, the voltage data DCOM applied to the common electrode VCOM may be supplied as the serial data SDAT, as shown in FIG. 19. In this case, it is preferable that a positive high voltage is applied as the high-potential power source and a negative high voltage is applied as the low-potential power source to the segment electrode VSEG.

Although any one of the high voltage level HVDD, the low-potential power source VSS or the high impedance is output as the first and second control signals S1 and S2 in the above-described embodiments, the invention is not limited thereto and, for example, one of the high voltage level HVDD or the low-potential power source VSS may be output as the first and second control signals S1 and S2.

As the electronic apparatus including the electrophoretic display device described in the fourth embodiment, there are, for example, a mobile phone, an outdoor mark, a car navigation system, an electronic organizer, an electronic calculator, a POS terminal, and a touch-panel-equipped device. Even when the electrophoretic display device is applied to the apparatuses, the same effects as the above-described embodiments can be obtained.

Although the white particles 31W charged with the negative polarity, the black particles 31B charged with the positive polarity and the dispersion medium 32 are sealed in the micro capsule 30 in the above-described embodiments, the invention is not limited thereto. For example, a dispersion medium colored with a black color and white electrophoretic particles charged with a positive polarity may be sealed in the micro capsule 30. Alternatively, electrophoretic particles for performing a color display and a dispersion medium may be sealed in the micro capsule 30.

In the above-described embodiments, the electrophoretic display device of a two-value display is described. The invention is applicable to a gradation-displaying electrophoretic display device.

Although a micro capsule method of sealing the electrophoretic particles 31 and the dispersion medium 32 by the micro capsule 30 is described in the above-described embodiments, the electrophoretic particles 31 and the dispersion medium 32 may be partitioned by a partition wall, instead of the micro capsule 30. The invention is applicable to a vertical electrophoretic method or a horizontal electrophoretic method without the micro capsule 30.

What is claimed is:

1. A driving device of a segment display type electrophoretic display panel including a common electrode, a plurality of segment electrodes which face the common electrode, and a dispersion system containing electrophoretic particles arranged between the common electrode and the segment electrodes, the driving device comprising:
a driving circuit which supplies a driving voltage having a voltage value according to plural pieces of display data, which are supplied as a series of serial data, to the segment electrodes,
wherein the driving circuit includes a switching circuit which switches the driving voltage according to the display data to a voltage value according to reverse data of the display data, on the basis of at least one external control signal input to the driving circuit, independent of the display data.

2. The driving device of the electrophoretic display panel according to claim 1, wherein the switching circuit switches the driving voltage to a voltage value having a predetermined level for displaying a predetermined gradation, regardless of the display data, on the basis of at least two external control signals.

3. The driving device of the electrophoretic display panel according to claim 2, wherein:
the at least two external control signals include a first external control signal and a second external control signal,
the switching circuit includes first and second transfer gates which are complementarily opened or closed on the basis of the level of the display data, and
the first external control signal is supplied to the segment electrodes through the first transfer gate as the driving voltage and the second external control signal is supplied to the segment electrodes through the second transfer gate as the driving voltage.

4. The driving device of the electrophoretic display panel according to claim 3, wherein each of the first transfer gate and the second transfer gate is configured by connecting a P-channel MOS transistor and an N-channel MOS transistor in parallel.

5. The driving device of the electrophoretic display panel according to claim 3, wherein the external control signal outputs any one of a high-potential power source level, a low-potential power source level or high impedance.

6. The driving device of the electrophoretic display panel according to claim 5, wherein the driving circuit includes a three-value output circuit which receives first and second generation signals for generating the external control signal and outputs any one of the high-potential power source level, the low-potential power source level or the high impedance, according to the levels of the first and second generation signals.

7. The driving device of the electrophoretic display panel according to claim 5, further comprising an output circuit which alternately applies the low-potential power source level and the high-potential power source level to the common electrode in each predetermined period, according to the voltage data supplied independent of the serial data,
wherein, when a voltage having the same potential as the driving voltage supplied to a predetermined segment electrode is supplied to the common electrode, the external control signal having the high impedance is supplied to the predetermined segment electrode.

8. The driving device of the electrophoretic display panel according to claim 1, wherein:
the driving circuit includes a serial/parallel converting circuit which includes a shift register and a data latch and converts the serial data to parallel data, and
a high-potential power source which can shift a power source voltage from a low voltage level to a high voltage level for driving the dispersion system is connected to the data latch.

9. A driving device of a segment display type electrophoretic display panel including a common electrode, a plurality of segment electrodes which face the common electrode, and a dispersion system containing electrophoretic particles arranged between the common electrode and the segment electrodes, the driving device comprising:
a driving circuit which supplies a driving voltage having a voltage value according to plural pieces of display data, which are supplied as a series of serial data, to the segment electrodes,
wherein the driving circuit includes a switching circuit which switches the driving voltage to a voltage value having a predetermined level, regardless of the display data, on the basis of at least two external control signals input to the driving circuit, independent of the display data.

10. A driving method of a segment display type electrophoretic display panel including a common electrode, a plurality of segment electrodes which face the common electrode, and a dispersion system containing electrophoretic particles arranged between the common electrode and the segment electrodes, the driving method comprising:
at a driving circuit, supplying a driving voltage having a voltage value according to plural pieces of display data,
which are supplied as a series of serial data, to the segment electrodes; and
switching the driving voltage according to the display data to a voltage value according to reverse data of the display data, on the basis of at least one external control signal input to the driving circuit, independent of the display data.

11. The driving method of the electrophoretic display panel according to claim 10, further comprising switching the driving voltage to a voltage value having a predetermined level for displaying a predetermined gradation, regardless of the display data, on the basis of at least two external control signals.

12. An electrophoretic display device comprising the driving device according to claim 1.

13. An electronic apparatus comprising the electrophoretic display device according to claim 12.
